(19) United States
(12) Patent Application Publication
(10) Pub. No.: US 2002/0172350 A1
(43) Pub. Date: Nov. 21, 2002

(54) Method for generating a final signal from a near-end signal and a far-end signal

(76) Inventors: Brent W. Edwards, San Francisco, CA (US); Sunil Puria, Mountain View, CA (US)

Correspondence Address: HAYNES BEFFEL & WOLFELD LLP, P O BOX 366, HALF MOON BAY, CA, 94019, US

(21) Appl. No.: 09/855,255

(22) Filed: May 15, 2001

(51) Int. Cl. H04M 1/00; H04M 9/00

(52) U.S. Cl. 379/392.01

(57) ABSTRACT

A method of processing a far-end signal and a near-end signal to produce a final signal, the far-end signal containing speech, the near-end signal containing speech and background noise. The method includes: determining an amplification gain based upon the near-end signal; removing a portion of the background noise from the near-end signal to create a noise-reduced near-end signal; combining the far-end signal with the noise-reduced near-end signal to create a combined signal; and amplifying the combined signal by the amplification gain to create the final signal.

### FIELD OF THE INVENTION

The present invention relates generally to the field of telephone sets connected to a telephone network and more specifically to the problem of using a telephone in a noisy environment.

### BACKGROUND

When a person uses a telephone in a noisy environment such as a noisy room, an airport, a car, a street comer or a restaurant, it can often be difficult to hear the person speaking at the other end (i.e., the “far-end”) of the connection over the background noise present at the listener's location (i.e., the “near-end”). Due to the variability of human speech, the far-end speaker's voice is sometimes intelligible over the near-end background noise and sometimes unintelligible. Moreover, the noise level at the near-end may itself vary over time, making the far-end speaker's voice level adequate sometimes and at inadequate at other times.

Although some telephones provide for control of the volume level of the telephone loudspeaker (i.e., the earpiece), such control is often unavailable. Moreover, manual adjustment of a volume control by the listener is undesirable since, as the background noise level changes, the user will be required to re-adjust the manual volume control in an attempt to maintain a preferred listening level. Generally, it is more desirable to provide an automatic (i.e., adaptive) control mechanism, rather than requiring the listener to adjust a manual volume control. One solution, which attempts to address this problem, has been proposed in U.S. Pat. No. 4,829,565, issued on May 9, 1989 to Goldberg. Goldberg discloses a telephone with an automated volume control whose gain is a function of the level of the background noise. The use of either conventional manual volume controls or an automatic mechanism such as that disclosed in Goldberg fails to adequately solve the background noise problem. In particular, these approaches fail to recognize the fact that by amplifying the signal that supplies the handset receiver (i.e., the loudspeaker), the side tone is also amplified. (The side tone is a well-known feed-through effect in a telephone. A portion of the input signal from the handset transmitter, i.e., the microphone, is mixed with the far-end signal received from the network. The resultant, combined signal is then supplied to the handset loudspeaker.) Since the side tone contains background noise, the background noise is disadvantageously amplified with the far-end signal. By amplifying both the far-end signal and the noise together, the degrading effect of the noise can actually become worse.

Another solution that attempts to address this problem has been proposed in U.S. Pat. No. 5,526,419, issued on Jun. 11, 1996 to Allen. Allen proposes a telephone that separates the far-end signal into a plurality of subbands and amplifies each subband by a gain factor. The gain factor that is applied to individual subbands of the far-end signal is proposed to be a function of a received signal indicative of the background noise. Allen then proposes combining the sidetone with the amplified far-end signal.

While Allen enhances the quality of the far-end signal, Allen does not enhance the near-end signal. Thus, a listener will find it difficult to hear his own voice because of the background noise.

Thus, a method is needed that enhances the quality of both the far-end signal and the near-end signal.

### SUMMARY OF INVENTION

One embodiment of the invention is a method of processing a far-end signal and a near-end signal to produce a final signal, the far-end signal containing speech, the near-end signal containing speech and background noise. The method includes: determining an amplification gain based upon the near-end signal; removing a portion of the background noise from the near-end signal to create a noise-reduced near-end signal; combining the far-end signal with the noise-reduced near-end signal to create a combined signal; and amplifying the combined signal by the amplification gain to create the final signal.

Another embodiment of the invention is a method of processing a far-end signal and a near-end signal to produce a final signal, the far-end signal containing speech, the near-end signal containing speech and background noise. This method includes: separating the near-end signal into a first near-end subband signal and a second near-end subband signal; determining a first amplification gain based upon the first near-end subband signal; determining a second amplification gain based upon the second near-end subband signal; removing a portion of the background noise from the near-end signal to create a noise-reduced near-end signal; combining the far-end signal with the noise-reduced near-end signal to create a combined signal; separating the combined signal into a first combined subband signal and a second combined subband signal; amplifying the first combined subband signal by the first amplification gain to create a first amplified subband signal; amplifying the second combined subband signal by the second amplification gain to create a second amplified subband signal; and combining the first combined subband signal and the second combined subband signal to create the final signal.

Another embodiment of the invention is yet another method of processing a far-end signal and a near-end signal to produce a final signal, the far-end signal containing speech, the near-end signal containing speech and background noise. This method includes: separating the near-end signal into a first near-end subband signal and a second near-end subband signal; determining the masking level of noise of the first near-end subband and signal; determining the masking level of noise of the second near-end subband signal; estimating the masking level of noise of a third near-end subband signal based upon the masking level of noise of the first near-end subband signal and the masking level of noise of the second near-end subband signal; determining a first amplification gain based upon the masking level of noise of the first near-end subband signal; determining a second amplification gain based upon the masking level of noise of the second near-end subband signal; determining a third amplification gain based upon the masking level of noise of the third near-end subband signal; removing a portion of the background noise from the near-end signal to create a noise-reduced near-end signal; combining the far-end signal with the noise-reduced near-end signal to create a combined signal; separating the combined signal into a first combined subband signal, a second combined subband signal, and a third combined subband signal; amplifying the first combined subband signal by the first amplification gain to create a first amplified subband signal; amplifying the second combined subband signal by the first amplification gain to create a second amplified subband signal; amplifying the third combined subband signal by the first amplification gain to create a third amplified subband signal; and combining the first combined subband signal, the second combined subband signal, and the third combined subband signal to create the final signal.

Still other embodiments of the invention are program storage devices containing computer readable instructions that when executed by a digital signal processor perform any of the above methods.

Other embodiments of the invention include telephones that include such program storage devices.

Still another embodiment of the invention is a communication device. The communication device includes: a transmitter/receiver adapted for a communication medium; control circuitry coupled to the transmitter/receiver that controls transmission, reception and control of audio signals; a speaker coupled to the control circuitry that renders audio signals audible; and a microphone coupled to the control circuitry that transforms sounds into a sidetone signal. The control circuitry includes: a noise filter that receives the sidetone signal and produces a noise reduced sidetone signal; and an amplifier that combines an audio signal received from the transmitter/receiver with the noise reduced sidetone signal to produce a combined signal, amplifies the combined signal according to a function responsive to the background noise in the sidetone, and provides an enhanced audio signal to the speaker.

### BRIEF DESCRIPTION OF THE FIGURES

FIG. 1 presents a flow diagram of one embodiment of the invention.

FIG. 2 presents one embodiment of a digital signal processor based system.

FIG. 3 presents a block diagram of program modules.

FIG. 4 presents another embodiment of the invention.

FIG. 5 presents still another embodiment of the invention.

FIG. 6 presents a flow diagram of another embodiment of the invention.

FIG. 7 presents a flow diagram of still another embodiment of the invention.

### DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of the present invention improve the signal-to-noise ratio of a far-end signal in the near-end listener's ear when the near-end listener is using a telephone in a noisy environment. In addition, embodiments of the present invention improve the signal-to-noise ratio of the near-end signal in the near-end listener's ear when the near-end listener is using the telephone in the noisy environment.

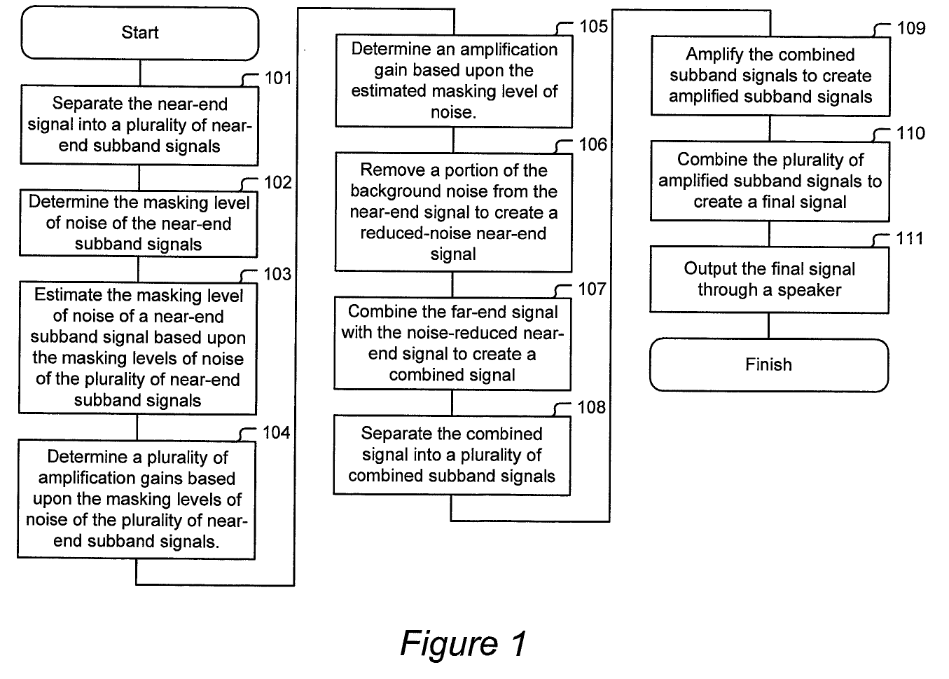

One embodiment of the invention, as shown in FIG. 1, is a method of processing a far-end signal and a near-end signal. The far-end signal typically contains a signal that may have been communicated over a telephone network to a (near-end) listener. The far-end signal may have been communicated over a telephone network such as the POTS (plain old telephone service) network or a more modem network such as ISDN (integrated services digital network) or FDDI (fiber distributed data interface). Alternatively, the far-end signal may have been communicated over a wireless network such as the cellular telephone network. The near-end signal, which in some embodiments of the invention would be the previously discussed sidetone, typically contains the listener's voice and often contains background noise.

5.1 Separating the Near-end Signal into Subbands

Referring to block 101 of FIG. 1, the near-end signal is first separated into a plurality of near-end subband signals. For example, the near-end signal may be separated into a 500 Hz±25 Hz subband signal, a 1 KHz±50 Hz subband signal, and a 3 KHz±150 Hz subband signal. In some embodiments of the invention, such as discussed immediately above, the subband widths are equal to 10% of the subband center frequency. In other embodiments of the invention, the widths of the subbands may be selected to equalize the equivalent rectangular bandwidth (ERB) of each subband signal.

The separation of the near-end signal into a plurality of near-end subband signals may be performed by passing the near-end signal through a plurality of analog filters, such as band pass filters. Alternatively, the near-end signal may be passed through a plurality of digital filters, such as FIR and/or IIR filters. In still other embodiments of the invention, the separation of the near-end signal may be passed through a Fast Fourier Transfer (FFT) procedure running on a digital signal processor.

5.2 Determining the Masking Level of Noise in the Near-end Subband Signals

Referring to block 102 of FIG. 1, after the near-end signal has been separated into a plurality of near-end subband signals, the masking level of noise in each subband can be determined. For example, the masking level of noise in a particular near-end subband signal can be determined by calculating the sound pressure level (dB) of that near-end subband signal.

5.3 Estimating the Masking Level of Noise of Additional Subband Signals

Referring to block 103 of FIG. 1, after the masking level of noise in the above near-end subband signals has been determined, the masking level of noise in one or more near-end subband signals may be estimated. For example, the masking level of noise of a near-end subband signal can be estimated by interpolating between the masking levels of noise of two other near-end subband signals. Alternatively, the masking level of noise of the near-end subband signal can be estimated by extrapolating the masking levels of noise of two other near-end subband signals.

In some embodiments of the invention, the masking level of noise of one or more near-end subband signals can be combined with a noise model to estimate the masking levels of noise of additional near-end subband signals. For example, the masking level of noise of a single near-end subband signal, when combined with a noise model of a typical automobile, can be used to estimate the masking level of additional near-end subband signals in an automobile.

The masking levels of noise of a plurality of near-in subband signals can also be utilized to select from one or more noise models. For example, the masking levels of noise of a plurality of near-end subband signals, can be compared to the masking levels of noise of a plurality of corresponding subband signals, i.e., same subband center frequency and same subband frequency width, in various noise models, to determine which noise model is most similar to the near-end noise. After the noise model has been selected, then the masking level of noise of one or more near-end subband signals can be combined with the selected noise model to estimate the masking levels of noise of additional near-end subband signals.

The above methods may be utilized to accurately estimate the masking levels of noise of approximately 20 near-end subband signals based upon three or four measured near-end subband signals.

5.4 Determining Subband Amplification Gains

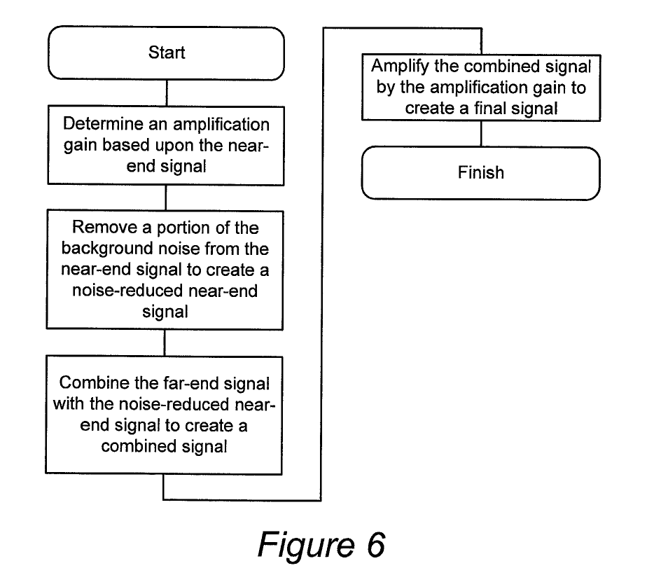

Referring to blocks 104 and 105 of FIG. 1, after the masking levels of noise of the plurality of near-end subband signals has been determined and/or estimated, subband amplification gains can then be determined. In one embodiment of the invention, the masking levels of noise of near-end subband signals (dB) are converted to sound pressure levels above the threshold of hearing audibility (dBHL) using equations known by those of skill in the art. Then, subband amplification gains are determined by using various protocols, such as but not limited to, the FIG. 6 protocol, the National Acoustics Laboratories' NAL-NL1 protocol, the Independent Hearing Aid Fitting Forum's protocol, the Desired Sensation Level input/output (DSL [i/o]) protocol, or the Cambridge protocol.

5.5 Removing a Portion of the Background Noise from the Near-end Signal

Referring to block 106 of FIG. 1, a portion of the background noise is removed from the near-end signal to create a noise-reduced near-end signal. Many methods are known by those of skill in the art for removing a portion of such background noise. For example, a portion of the background noise from the near-end signal can be removed by filtering the near-end signal with a high-pass filter. Alternatively, a portion of the background noise can be removed by filtering the near-end signal with a high-pass filter and suppressing the DC component of the near-end signal.

Still other embodiments of the invention use the well know spectral subtraction technique to remove a portion of the background noise from the near-end signal. See for example, Boll, “Suppression of Acoustic Noise in Speech using Spectral Subtraction,” IEEE Trans. on Acoustics, Speech and Signal Processing, Vol. ASSP-27, No. 2, April, 1979, p. 113. Generally, the spectral subtraction technique estimates the spectral content of “clean” speech by explicitly subtracting the spectral content of background noise from speech signals that include background noise. One implementation of the spectral subtraction technique is proposed in U.S. Pat. No. 5,742,927 issued on Apr. 21, 1998 to Crozier, which is hereby incorporated by reference.

Still other embodiments of the invention utilize a technique known as spectral scaling to remove a portion of the background noise from the near-end signal. See for example, Eger, “A Nonlinear Processing Technique for Speech Enhancement,” Proc. ICASSP 1983(IEEE) pp. 18A.1.1-18.A.1.4 and U.S. Pat. No. 5,133,013 issued on Jul. 21, 1992 to Munday.

Still other embodiments of the invention utilize other known noise suppression techniques, such as cepstral subtraction and Weiner filtering to remove a portion of the background noise from the near-end signal.

5.6 Combining the Far-end Signal with the Noise-reduced Near-end Signal

Referring to block 107 of FIG. 1, the noise-reduced near-end signal is combined with the far-end signal to create a combined signal. In one embodiment of the invention, the two signals are combined within a digital signal processor. In another embodiment of the invention, the two signals are combined in an adder of conventional design.

5.7 Amplifying the Combined Signal

Referring to blocks 108-1 10 of FIG. 1, the combined signal is then processed by a multiband amplifier that has been set to amplify different subbands of the combined signal by the subband amplification gains determined in Section 5.4. Multiband amplifiers are well known by those of skill in the art. See, for example, U.S. Pat. No. 6,198,830, issued on Mar. 6, 2001 to Holbe and U.S. Pat. No. 5,526,419, issued on Jun. 11, 1996 to Allen.

In one illustrative multiband amplifier, referring to block 108 of FIG. 1, the combined signal will first be separated into a plurality of combined subband signals. For example, in one embodiment the combined signal may be separated into 20 combined subband signals. Then, referring to block 109, each of these signals is amplified by a subband amplification gain to create amplified combined subband signals. Finally, referring to block 110, the amplified combined subband signals are combined to create a final signal.

5.8 Outputting the Final Signal

Referring to block 111 of FIG. 1, after a multiband amplifier has processed the combined signal, the resulting final signal is output through a speaker, such as a telephone handset speaker.

5.9 Digital Signal Processor Implementation

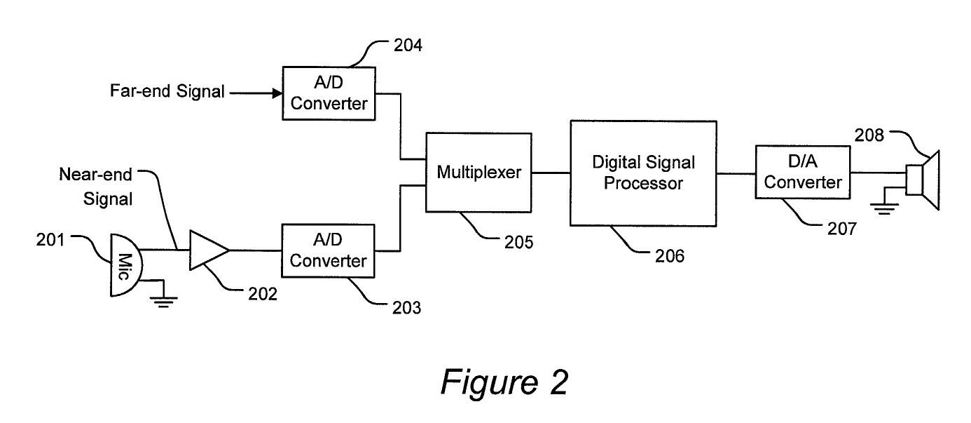

FIG. 2 presents one embodiment of a digital signal processor based system for performing the methods described above. The apparatus includes a microphone 201 for converting a user's voice and background noise into a near-end signal. The output of the microphone 201 is coupled to a conventional preamp 202 that is also coupled to a first analog-to-digital converter 203. The analog-to-digital converter 203 is conventional. The output of the first analog-to-digital converter 203 is coupled to a conventional multiplexer 205. The output of the multiplexer 205 is coupled to a digital signal processor 206 that is programmed to perform one of the methods described above. The output of the digital signal processor 206 is coupled a digital-to-analog converter 207. The digital-to-analog converter 207 is conventional. The output of the digital-to analog converter 207 is coupled to a conventional speaker 208. A second analog-to-digital converter 204 receives the far-end signal. The output of the second analog-to-digital converter 204 is coupled to the multiplexer 205.

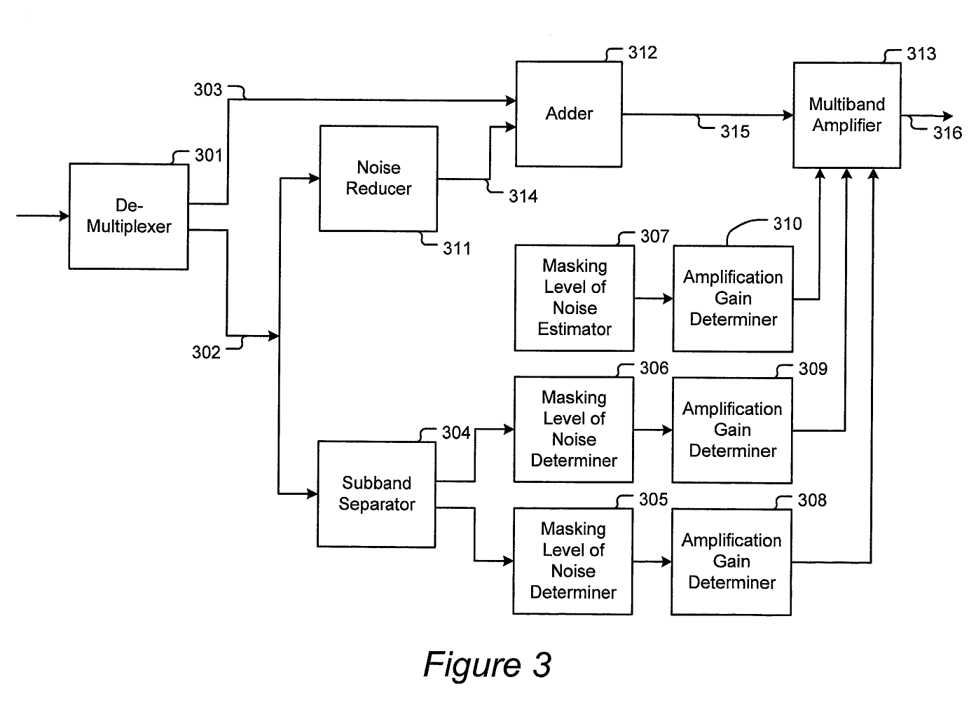

FIG. 3 presents a block diagram of program modules that could be included in a digital signal processor 206 that was programmed to perform some of the embodiments of the invention. The demultiplexer 301 receives the output from multiplexer 205 and separates the near-end signal 302 from the far-end signal 303. Subband separator module 304 receives the near-end signal and, as discussed in Section 5.1, generates near-end subband signals. The masking level of noise determiner modules 305 and 306 receive the near-end subband signals, which, as discussed in Section 5.2, determine the masking level of noise in each near-end subband signal. In some embodiments of the invention, the outputs of the masking level of noise determiner modules 305 and 306 are provided to the masking level of noise estimator module 307 (data path between masking level of noise determiner modules 305 and 306 and the masking level of noise estimator module 307 is not shown). Thus, as described in Section 5.3, an additional masking level of noise can be estimated. Amplification gain determiner modules 308, 309, and 310 receive the outputs of the masking level of noise determiner modules 305 and 306 and the masking level of noise estimator module 307. As discussed in Section 5.4, the amplification gain determiner modules 308, 309, and 310 provide amplification gains to the multiband amplifier 313.

The near-end signal 302 is also provided to the noise reducer module 311. As discussed in Section 5.5, the noise reducer module removes a portion of the background noise from the near-end signal and creates a noise-reduced near-end signal 314. This signal 314 is received by an adder module 312, which also receives the far-end signal 303 from the demultiplexer 301. As discussed in Section 5.6, the adder module combines the far-end signal with the noise-reduced near-end signal to create a combined signal 315. The multiband amplifier 313 receives the combined signal 315. As discussed in Section 5.7, the multiband amplifier 313 then multiplies subbands of the combined signal 315 to generate a final signal 316.

5.10 Other Embodiments of the Invention

In other embodiments of the invention, a user would preprogram subband amplification gains into a telephone. In one embodiment of the invention, the subband amplification gains could be programmed via the telephone keypad. In another embodiment of the invention, the subband amplification gains could be encoded in the far-end signal. In still other embodiments of the invention, the subband amplification gains could be input into the telephone via voice recognition. The subband amplification gains may be based upon the user's hearing ability and/or the anticipated background noise that is present when the telephone is typically used.

In some embodiments of the invention, the amplification gain determiner modules 308, 309, and 310 first determine subband amplification gains as discussed in Section 5.4. Next, each module retrieves a preprogrammed subband amplification gain. Then, the module provides the multiband amplifier 313 with the larger of either the determined subband amplification gain or the preprogrammed subband amplification gain.

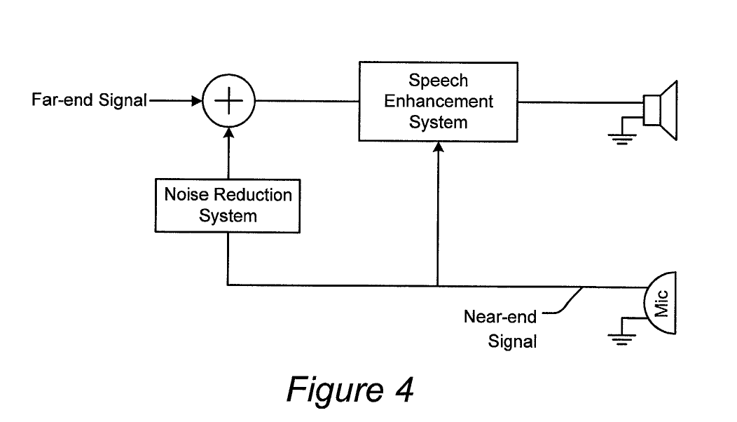

FIG. 4 presents a block diagram of another embodiment of the invention. In this embodiment, the microphone converts sound that includes background noise into a near-end signal. The near-end signal is provided to a noise reduction system and a speech enhancement system. The noise reduction system eliminates a portion of the background noise from the near-in signal and produces a noise-reduced near-end signal. An adder combines the far-end signal and the noise-reduced near-end signal to produce a combined signal. In some embodiments of the invention, the speech enhancement system amplifies the combined signal. In other embodiments of the invention, the speech enhancement system separates the combined signal into a plurality of combined subband signals. In such embodiments, the combined subband signals are amplified using one of the multiband compression methods discussed above, and then combined into a final signal, which is provided to the speaker.

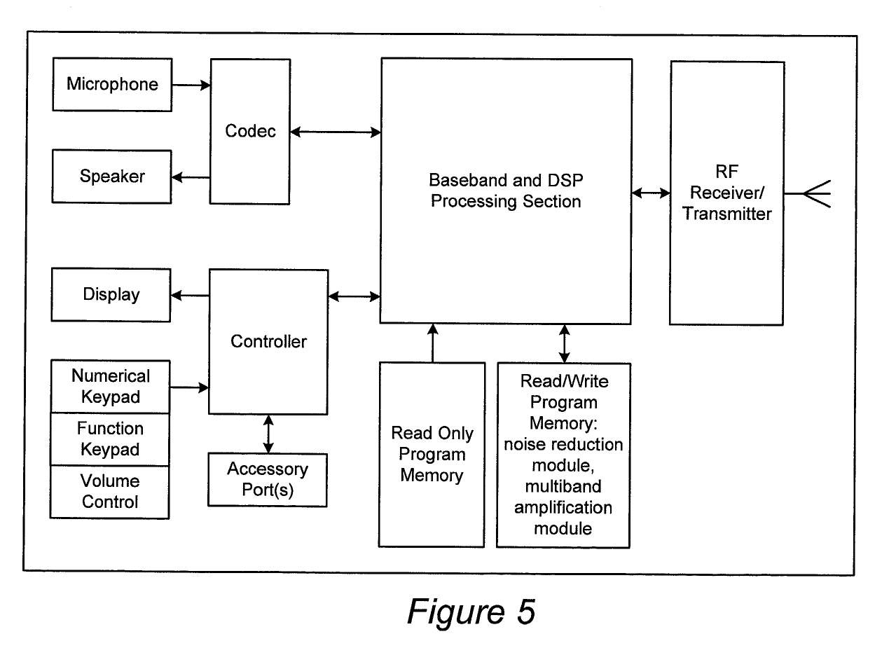

Still another embodiment is presented in FIG. 5. FIG. 5 presents a block diagram of a communication device, such as a cellular telephone. The communication device includes a transmitter/receiver and control circuitry that is coupled to the transmitter/receiver. The control circuitry controls transmission, reception, and processing of audio signals. The communication device also includes a speaker and a microphone that are coupled to the control circuitry. The speaker renders audio signals audible and the microphone converts sound into a sidetone signal. The control circuitry includes a noise filter that receives a sidetone signal from a microphone and produces a noise-reduced sidetone. The control circuitry also includes an amplifier that combines an audio signal received from the transmitter/receiver with the noise-reduced sidetone to produce a combined signal. The amplifier also amplifies the combined signal according to a function that is responsive to the background noise in the sidetone signal. Further, the amplifier provides an enhanced audio signal to the speaker.

5.11 Conclusion

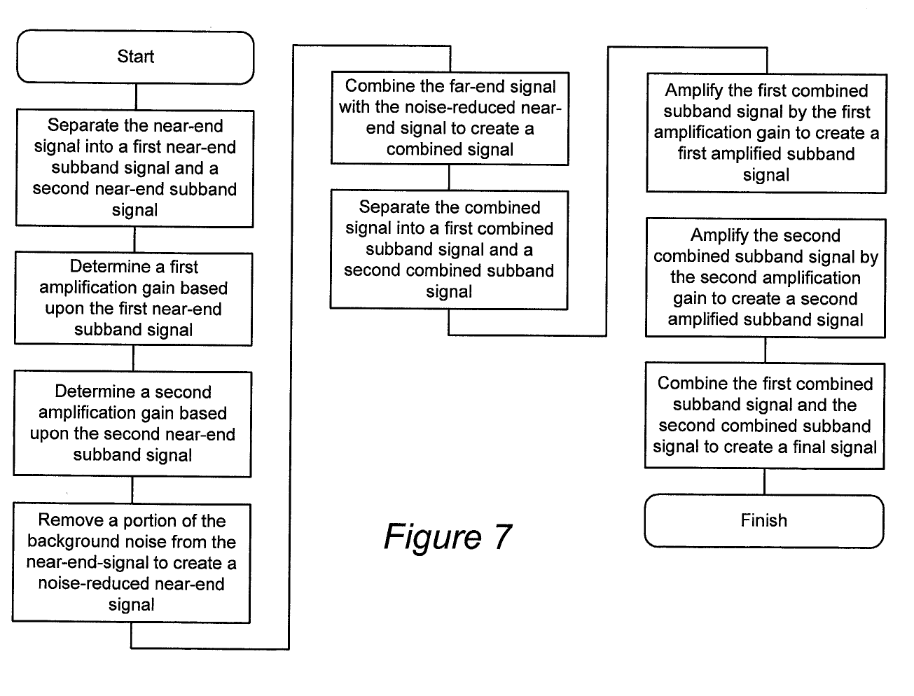

The foregoing descriptions of embodiments of the present invention have been presented for purposes of illustration and description only. They are not intended to be exhaustive or to limit the present invention to the forms disclosed. For example, the methods shown in FIGS. 6 and 7 present additional embodiments of the invention. Similarly, a digital signal processor that contains computer readable instructions that when executed by the digital signal processor perform any of the above methods is encompassed by the invention. Additionally, the invention is not intended to be limited to the specifically disclosed methods for determining amplification gains based upon sound pressure levels or sound pressure levels above the threshold of hearing audibility. The disclosed methods are only illustrative. Other methods known by those skilled in the art for determining amplification gains may be utilized. Further, the invention is not intended to be limited to specifically disclosed methods for removing a portion of the background noise from the near-end signal. The invention is likewise not intended to require a digital signal processor. Any device, such as a micro-controller or a microprocessor, that is capable of receiving digital data and outputting digital data may be utilized to perform the above methods. The disclosed methods are only illustrative and other methods known by those skilled in the art for removing background noise may be utilized.

Accordingly, many modifications and variations will be apparent to practitioners skilled in the art. Additionally, the above disclosure is not intended to limit the present invention. The scope of the present invention is defined by the appended claims.

It is claimed:

1. A method of processing a far-end signal and a near-end signal to produce a final signal, the far-end signal containing speech, the near-end signal containing speech and background noise, the method comprising:
a) determining an amplification gain based upon the near-end signal;
b) removing a portion of the background noise from the near-end signal to create a noise-reduced near-end signal;
c) combining the far-end signal with the noise-reduced near-end signal to create a combined signal; and
d) amplifying the combined signal by the amplification gain to create the final signal.

2. The method of claim 1, wherein the act of determining the amplification gain includes determining the masking level of the near-end signal.

3. The method of claim 1, wherein the act of determining the amplification gain includes determining the sound pressure level of the near-end signal.

4. The method of claim 1, wherein the act of determining the amplification gain includes determining the sound pressure level above the threshold of hearing audibility.

5. The method of claim 1, wherein the act of determining the amplification gain includes determining the amplification gain via the FIG. 6. protocol.

6. The method of claim 1, wherein the act of determining the amplification gain includes determining the amplification gain via the NAL-NL1 protocol.

7. The method of claim 1, wherein the act of determining the amplification gain includes determining the amplification gain via the Independent Hearing Aid Fitting Forum protocol.

8. The method of claim 1, wherein the act of determining the amplification gain includes determining the amplification gain via the Desired Sensation Level input/output protocol.

9. The method of claim 1, wherein the act of determining the amplification gain includes determining the amplification gain via the Cambridge protocol.

10. The method of claim 1, wherein the act of removing a portion of the background noise from the near-end signal includes filtering the near-end signal with a high-pass filter.

11. The method of claim 1, wherein the act of removing a portion of the background noise from the near-end signal includes filtering the near-end signal with a high-pass filter and suppression of the DC component of the near-end signal.

12. The method of claim 1, wherein the act of removing a portion of the background noise from the near-end signal includes removing a portion of the background noise via the spectral subtraction technique.

13. A method of processing a far-end signal and a near-end signal to produce a final signal, the far-end signal containing speech, the near-end signal containing speech and background noise, the method comprising:
a) separating the near-end signal into a first near-end subband signal and a second near-end subband signal;
b) determining a first amplification gain based upon the first near-end subband signal;
c) determining a second amplification gain based upon the second near-end subband signal;
d) removing a portion of the background noise from the near-end signal to create a noise-reduced near-end signal;
e) combining the far-end signal with the noise-reduced near-end signal to create a combined signal;
f) separating the combined signal into a first combined subband signal and a second combined subband signal;
g) amplifying the first combined subband signal by the first amplification gain to create a first amplified subband signal;
h) amplifying the second combined subband signal by the second amplification gain to create a second amplified subband signal; and
i) combining the first combined subband signal and the second combined subband signal to create the final signal.

14. The method of claim 13, wherein the act of determining the first amplification gain includes determining the masking level of the first near-end subband signal.

15. The method of claim 13, wherein the act of determining the first amplification gain includes determining the sound pressure level of the first near-end subband signal.

16. The method of claim 13, wherein the act of determining the first amplification gain includes determining the sound pressure level above the threshold of hearing audibility of the first near-end subband signal.

17. The method of claim 13, wherein the act of determining the first amplification gain includes determining the first amplification gain via the FIG. 6. protocol.

18. The method of claim 13, wherein the act of determining the first amplification gain includes determining the first amplification via the NAL-NL1 protocol.

19. The method of claim 13, wherein the act of determining the first amplification gain includes determining the first amplification via the Independent Hearing Aid Fitting Forum protocol.

20. The method of claim 13, wherein the act of determining the first amplification gain includes determining the first amplification via the Desired Sensation Level input/output protocol.

21. The method of claim 13, wherein the act of determining the first amplification gain includes determining the first amplification via the Cambridge protocol.

22. The method of claim 13, wherein the act of removing a portion of the background noise from the near-end signal includes filtering the near-end signal with a high-pass filter.

23. The method of claim 13, wherein the act of removing a portion of the background noise from the near-end signal includes filtering the near-end signal with a high-pass filter and suppression of the DC component of the near-end signal.

24. The method of claim 13, wherein the act of removing a portion of the background noise from the near-end signal includes removing a portion of the background noise via the spectral subtraction technique.

25. A method of processing a far-end signal and a near-end signal to produce a final signal, the far-end signal containing speech, the near-end signal containing speech and background noise, the method comprising:
a) separating the near-end signal into a first near-end subband signal and a second near-end subband signal;
b) determining the masking level of noise of the first near-end subband signal;
c) determining the masking level of noise of the second near-end subband signal;
d) estimating the masking level of noise of a third near-end subband signal based upon the masking level of noise of the first near-end subband signal and the masking level of noise of the second near-end subband signal;
e) determining a first amplification gain based upon the masking level of noise of the first near-end subband signal;
f) determining a second amplification gain based upon the masking level of noise of the second near-end subband signal;
g) determining a third amplification gain based upon the masking level of noise of the third near-end subband signal;
h) removing a portion of the background noise from the near-end signal to create a noise-reduced near-end signal;
i) combining the far-end signal with the noise-reduced near-end signal to create a combined signal;
j) separating the combined signal into a first combined subband signal, a second combined subband signal, and a third combined subband signal;
k) amplifying the first combined subband signal by the first amplification gain to create a first amplified subband signal;
l) amplifying the second combined subband signal by the first amplification gain to create a second amplified subband signal;
m) amplifying the third combined subband signal by the first amplification gain to create a third amplified subband signal; and
n) combining the first combined subband signal, the second combined subband signal, and the third combined subband signal to create the final signal.

26. A program storage device containing computer readable instructions that when executed by a digital signal processor perform the method of claim 1.

27. A program storage device containing computer readable instructions that when executed by a digital signal processor perform the method of claim 13.

28. A program storage device containing computer readable instructions that when executed by a digital signal processor perform the method of claim 25.

29. A telephone containing a digital signal processor and the program storage device of claim 26.

30. The telephone of claim 29 wherein the telephone is a cellular telephone.

31. A telephone containing a digital signal processor and the program storage device of claim 27.

32. The telephone of claim 31 wherein the telephone is a cellular telephone.

33. A telephone containing a digital signal processor and the program storage device of claim 27.

34. The telephone of claim 33 wherein the telephone is a cellular telephone.

35. A communication device comprising:
a) a transmitter/receiver adapted for a communication medium;
b) control circuitry coupled to the transmitter/receiver that controls transmission, reception and control of audio signals;
c) a speaker coupled to the control circuitry that renders audio signals audible; and
d) a microphone coupled to the control circuitry that transforms sounds into a sidetone signal;
wherein said control circuitry includes:
a noise filter that receives the sidetone signal and produces a noise-reduced sidetone signal; and
an amplifier that combines an audio signal received from the transmitter/receiver with the noise-reduced sidetone signal to produce a combined signal, amplifies the combined signal according to a function responsive to the background noise in the sidetone, and provides an enhanced audio signal to the speaker.

36. The communication device of claim 35, wherein the control circuitry includes a digital signal processor.

37. The communication device of claim 35, wherein the noise filter includes instructions executed by the control circuitry.

38. The communication device of claim 35, wherein the noise filter executes a process to reduce background noise in the sidetone signal.

39. The communication device of claim 35, wherein the noise filter executes a process including determining a masking level of noise of the sidetone signal.

40. The communication device of claim 35, wherein the noise filter executes a process including determining a masking level of noise of a sidetone subband signal.

41. The communication device of claim 35, wherein the noise filter executes a process including estimating the masking level of noise of a sidetone subband signal.

42. The communication device of claim 35, wherein the amplifier includes instructions executed by the control circuitry.

43. The communication device of claim 35, wherein the amplifier executes a process including determining the spectral density of the background noise in the sidetone to produce parameters for multiband compression of the combined signal.

44. The communication device of claim 35, wherein the amplifier executes a process including separating the combined signal into a plurality of combined subband signals.

45. The communication device of claim 35, wherein the amplifier executes a process including separating the combined signal into a plurality of combined subband signals and amplifying the plurality of subband signals.

46. The communication device of claim 35, including a second microphone coupled to the amplifier that is used for estimating background noise.
